(19) United States
(12) Patent Application Publication
(10) Pub. No.: US 2010/0299548 A1
(43) Pub. Date: Nov. 25, 2010

(54) Blade server

(75) Inventors: Ibrahim Hikmat Chadirchi, Hertford (GB); Stephen John Hill, Grantchester (GB); John Julian Sinton, Milton (GB); Spencer John Saunders, Biggleswade (GB)

Correspondence Address: NIXON & VANDERHYE P.C., 901 N. Glebe Road, 11th Floor, Arlington, VA, 22203-1808, US

(73) Assignee: ARM Limited, Cambridge (GB)

(21) Appl. No.: 12/659,089

(22) Filed: Feb. 24, 2010

(30) Foreign Application Priority Data
Feb. 25, 2009 (GB) 0903229.3

(51) Int. Cl. G06F 1/30

(52) U.S. Cl. 713/340; 713/300

(57) ABSTRACT

A blade server 2 is provided with a processor 6 for executing program instructions and an electrical connector 12 for connecting to a blade enclosure 22. The blade server 2 also includes a power controller 18 connected to a plurality of power supply batteries 14, 16 which are provided on the blade server 2 itself. If the power controller 18 detects that the main power supply supplied via the electrical connector 12 has been interrupted, then a backup power supply to the processor is provided from the on-board power supply batteries 14, 16. The batteries 14, 16 on each blade are periodically discharged and recharged in turn to check their proper function.

### BACKGROUND OF THE INVENTION

1. Field of the Invention

This invention relates to the field of blade servers. More particularly, this invention relates to the provision of electrical power to blade servers.

2. Description of the Prior Art

It is known to provide blade servers and blade server arrays for use in high density computing applications. Typically blade servers comprise a bare circuit board (without an individual enclosure) to which is attached at least a processor for executing a stream of program instructions. The individual blade servers are connected via respective electrical connectors to a blade enclosure. A blade server array is provided by a blade enclosure housing a plurality of blade servers. Electrical power is supplied to the individual blade servers via the blade enclosure through the electrical connector. Such blade server arrays have a number of practical advantages in high performance applications, such as scaleability, redundancy, parallel processing capabilities etc. Blade servers and blade server arrays are typically aimed at large scale computer environments in which high performance processors are utilised. Such high performance processors typically have relatively large power requirements necessitating large and powerful main power supplies and large and powerful backup supplies together with appropriate cooling mechanisms to deal with the heat generated. In such high density computing environments the backup power supplies can represent a significant investment in terms of both capital outlay and maintenance.

### SUMMARY OF THE INVENTION

Viewed from one aspect the present invention provides blade server for connection to a blade enclosure as one of a plurality of blade servers connected to said blade enclosure, said blade server comprising:

at least one processor responsive to at least one stream of program instructions to perform processing operations;

an electrical connector configured to provide electrical connection with said blade enclosure, at least a main power supply for said at least one processor being passed from said blade enclosure through said electrical connector to said at least one processor;

a plurality of power supply batteries; and

power controller circuitry coupled to said plurality of power supply batteries and to said main power supply and configured:

(i) to provide a power supply to said at least one processor from at least one of said plurality of power supply batteries during an interruption of said main power supply such that said processor continues to be responsive to said stream of program instructions to perform said processing operations; and

(ii) periodically at least partially to discharge and to recharge each of said plurality of power supply batteries in turn.

The present technique recognises that with the advent of more power efficient processors and higher power density batteries it becomes possible to provide blade servers with an on-board backup battery power supply. While this might initially seem counter to the normal design trend within this field whereby a single large, complex and capable uninterruptible power supply is provided and shared by a plurality of blade servers, the present technique provides a number of advantages. One advantage is that the cost and maintenance overhead associated with the provision of such centralised uninterruptible power supplies is reduced. Further, the on-board nature of the backup power supply provided to the blade server tends to make it more reliable; providing separate backup power supplies to each of the blade servers means that, if one of these backup power supplies is defective, then it need only impact the individual blade server whereas if a centralised uninterruptible power supply is defective then this can render inoperative a large number of blade servers with severe consequences. The configuration and testing of uninterruptible power supplies requires labour and ongoing effort. If more blade servers are added to the array or installation, then the centralised uninterruptible power supply may need configuring for these additional blade servers and checking to ensure that it is of sufficient capacity and will operate correctly if needed. In contrast, the on-board backup power supplies of the present technique are automatically added into the overall system as each blade server is added to that system and the need for testing and reconfiguration is reduced. The maintenance overhead of the many batteries may be reduced by providing an on-blade power controller that periodically discharges and recharges each battery on that blade in turn. Providing multiple batteries on a blade has the advantage that if the main power fails just as one of the on-blade batteries is fully discharged as part of the on-going automatic maintenance, then other on-blade batteries will be available to provide power.

The power controller circuitry may include communication circuitry configured to communicate with the power controller circuitry of one or more other blade serves so as to facilitate the coordinated management of the batteries within the different blades. Thus, for example, while one of the blade serves is conducting is periodic discharge and recharge of each of its plurality of batteries in turn, then the other blade servers may be blocked from performing similar maintenance operations so that the overall battery capacity of all of the blades is not unduly reduced. There is no need for all of the blades to conduct their battery health checks simultaneously and it is preferable if the power controller circuitry of the different blades communicate with one another to stagger the battery health operations.

When the power controller circuitry discharges a battery it may monitor the discharge so as to derive a status parameter indicative of a capacity of that battery. This status parameter may be indicative of the measured capacity as a proportion of the nominal capacity of the battery. Thus, a battery may be tested and found to produce, for example, 90% of its nominal capacity. If the measured capacity falls below a threshold value then a message indicating that the given battery should be replaced may be generated by the power controller circuitry. In this way, individual batteries may have their performance periodically checked and if necessary a requirement to change that battery may be indicated to the user of the system.

The main power supply provided to the blade server will have a main power supply voltage. This main power supply voltage is normally stepped down to a level suitable for powering the electronics of a blade server. An advantage of providing the plurality of batteries for backup purposes upon the blade server itself is that these batteries may power the blade server without having to step up their output voltage to the main power supply voltage in order to have this simply stepped down at a later stage into a voltage suitable for the electronics. This contrasts with a typical centralised UPS in which, for example, the output voltage of a lead-acid battery is stepped up to a higher mains power voltage before being stepped down again to the voltage required by the electronic circuitry. Such unnecessary stepping up and stepping down of voltage levels reduces the efficiency and compromises the survival time provided by the backup battery for a given amount of battery capacity. Providing the plurality of batteries on-blade at least reduces this inefficiency and accordingly extends the survival time for a given battery capacity.

It will be appreciated that the electrical connector providing the electrical connection between the blade server and the blade enclosure can take a wide variety of different forms and may be unitary or split in to separate portions. At least a main power supply is provided through this electrical connector. The electrical connector need not necessarily be conductive, e.g. on inductive connection may be possible to pass the main power supply given the low power consumption of blade servers possible with low power consumption processors. The main power supply could also be combined with other signals, such as utilising power-over-ethernet connections in which the power supply for a circuit is provided via its network connection. Connections other than the power connection could be provided in ways separate from the electrical connector, such as via wireless data communications (e.g. optical or radio).

The power controller circuitry responsible for switching between the main power supply and the backup power supply from the batteries may also be responsible for charging the power supply batteries using the main power supply when this is available. Thus, the on-board power supply batteries can be kept charged and ready for backup use when the main power supply is available under control of the on-board power controller circuitry provided within the blade server.

As previously mentioned, the electrical connector may pass only the main power supply to the blade server. However, it is convenient if this electrical connector also passes one or more further signals including at least one of a network transmission signal, a data signal exchanged with non-volatile storage media (such as a hard disk(s)) and a status signal indicative of a current status of the blade server (e.g. healthy operation, operation using the on-board backup power supply, utilisation information etc).

The batteries of one blade server may also be used to provide a power supply to another blade server, e.g. during a peak in power requirements of the other blade server and/or due to a defective or exhausted battery on the other blade server.

Viewed from another aspect the present invention provides a blade server array comprising:

a blade enclosure; and

a plurality of blade servers connected to said blade enclosure, wherein

at least one of said plurality of said blade servers comprises:

at least one processor responsive to at least one stream of program instructions to perform processing operations;

an electrical connector configured to provide electrical connection with said blade enclosure, at least a main power supply for said at least one processor being passed from said blade enclosure through said electrical connector to said at least one processor;

a plurality of power supply batteries; and

power controller circuitry coupled to said plurality of power supply batteries and to said main power supply and configured:

(i) to provide a power supply to said at least one processor from at least one of said plurality of power supply batteries during an interruption of said main power supply such that said processor continues to be responsive to said stream of program instructions to perform said processing operations; and

(ii) periodically at least partially to discharge and to recharge each of said plurality of power supply batteries in turn.

Viewed from a further aspect the present invention provides a blade server means for connecting to a blade enclosure means for housing a plurality of blade server means connected to said blade enclosure means, said blade server means comprising:

at least one processor means for performing processing operations in response to at least one stream of program instructions;

electrical connector means for providing electrical connection with said blade enclosure means, at least a main power supply for said at least one processor means being passed from said blade enclosure means through said electrical connector means to said at least one processor means;

a plurality of power supply battery means for storing electrical energy; and

power controller means coupled to said plurality of power supply battery means and to said main power supply:

(i) for providing a power supply to said at least one processor means from at least one of said, plurality of power supply battery means during an interruption of said main power supply such that said processor means continues to be responsive to said stream of program instructions to perform said processing operations; and

(ii) periodically at least partially for discharging and for recharging each of said plurality of power supply battery means in turn.

Viewed from a further aspect the present invention provides a blade server array means comprising:

blade enclosure means; and

a plurality of blade server means connected to said blade enclosure means,

wherein

at least one processor means for performing processing operations in response to at least one stream of program instructions;

electrical connector means for providing electrical connection with said blade enclosure means, at least a main power supply for said at least one processor means being passed from said blade enclosure means through said electrical connector means to said at least one processor means;

a plurality of power supply battery means for storing electrical energy; and

power controller means coupled to said plurality of power supply battery means and to said main power supply:

(i) for providing a power supply to said at least one processor means from at least one of said plurality of power supply battery means during an interruption of said main power supply such that said processor means continues to be responsive to said stream of program instructions to perform said processing operations; and

(ii) periodically at least partially for discharging and for recharging each of said plurality of power supply battery means in turn.

Viewed from a further aspect the present invention provides a method of providing electrical power to a blade server within a blade enclosure, said method comprising the steps of:

when a main power supply is available, supplying said main power supply to said blade server via a blade enclosure and an electrical connector providing an electrical connection between said blade enclosure and said blade server;

when said main power supply is not available, using a battery power supply from a plurality of power supply batteries formed as part of said blade server to power said blade server such that said blade server continues to execute program instructions; and

periodically at least partially discharging and recharging each of said plurality of power supply batteries in turn.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a blade server with an on-board backup battery power supply;

FIG. 2 schematically illustrates a blade server array including a blade enclosure and a plurality of blade servers;

FIG. 3 is a flow diagram schematically illustrating the control of switching between a main power supply and an on-board battery power supply;

FIG. 4 is a flow diagram schematically illustrating the period exercise through discharge and recharge of on-board batteries;

FIG. 5 is a chart illustrating the charging and discharging of a plurality of on-board batteries in accordance with the technique discussed in relation to FIG. 4;

FIG. 6 is a flow diagram schematically illustrating a process for periodically discharging and recharging each battery in turn upon a blade server;

FIG. 7 is a diagram schematically illustrating the change in the state of charge of a plurality of different batteries provided on a blade server with time as these batteries are subject to discharge and recharge in turn;

FIG. 8 is a diagram schematically illustrating the variation of battery output voltage and the current drawn from a battery with time as the battery is discharged; and

FIG. 9 schematically illustrates a portion of the circuitry for controlling the discharging and recharging of a plurality of batteries provided on a blade server.

### DESCRIPTION OF THE EMBODIMENTS

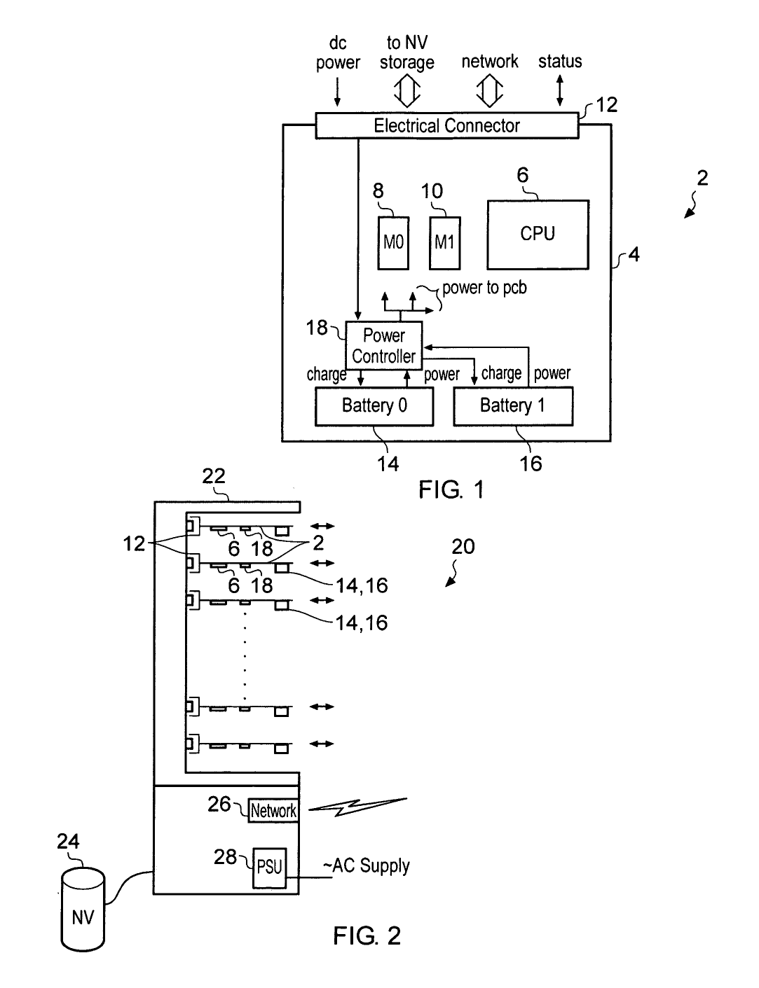

FIG. 1 illustrates a blade server 2 in the form of a printed circuit board 4 carrying a plurality of components, such as a processor 6 and on-board memory 8, 10 which together permit execution of a stream of program instructions. Some of the on-board memory 8, 10 may provide on-board non-volatile storage, e.g. a flash disk drive. It will be appreciated that many further on-board computing components are typically be provided such as, network interface units, memory controllers for communicating with non-volatile memory, such as hard disk drives located outside of the blade server 2, etc. An electrical connector 12 is provided at one edge of the blade server 2 and, in use, is connected to a blade enclosure. The electrical connector passes the main power supply (DC power) to the blade server 2 with this main power supply being used to power the blade server 2 when it is available. The electrical connector may additionally pass signals communicating with non-volatile storage (such as a hard disk drive, RAID array, etc), network communication signals (such as communication signals to other blade servers or to a wide area network, e.g. ethernet) and status signals (such as power status, utilisation status, diagnostic status etc). The electrical connector 12 may be unitary or may be split into separate discrete connectors for different groups of signals. In some embodiments the different type of signals above may be combined, e.g. a single physical channel could communicate network, storage and status signals.

Also shown in FIG. 1 are a plurality of power supply batteries 14, 16 which are provided on the printed circuit board 4. These power supply batteries 14, 16 are connected to a power controller 18 and are charged via this power controller 18. If the main power supply is not available, then the power supply batteries 14, 16 continue to be used to supply electrical power to the blade server 2 until the power supply batteries are discharged. Thus, when the main power supply is available via the electrical connector 12, the power controller 18 serves to supply electrical power to the blade server 2 derived from the power supply batteries 14, 16 while also charging these as necessary. When the main power supply is not available via the electrical connector 12, the power controller 18 still provides a power supply derived from the power supply batteries 14, 16 such that the processor 6 can continue to execute the program instructions and perform its required data processing operations.

The processor 6 of the blade server 2 in this type of system will typically be a low-power processor, such as an ARM processor. These low-power processors typically consume less than one Watt of power making the provision of on-board backup power supply batteries a practical proposition as this will provide enough time on the battery power supply without charging to facilitate the restoration of the main power supply, or at least a graceful shutdown. The power supply batteries 14, 16 will typically be batteries with a high power density, such as lithium ion batteries, which are relatively inexpensive for their performance given their widespread use in other applications.

FIG. 2 schematically illustrates a blade server array 20 comprising a plurality of blade servers 2 each having its on-board processor 6, power controller circuitry 18 and power supply batteries 14, 16. These blade servers 2 are connected via their electrical connectors 12 to a blade enclosure 22. The blade enclosure 22 also provides a connection to off-board non-volatile storage 24, such as a shared hard disk drive, a network connection 26 and a main power supply 28. In operation, the main power supply 28 provides the main power supply to each of the blade servers 2 via the electrical connectors 12. When the main power supply 28 fails, such as due to a power failure, then the on-board power controller circuitry 18 stop charging and continues to draw electrical power from the on-board battery power supplies 14, 16.

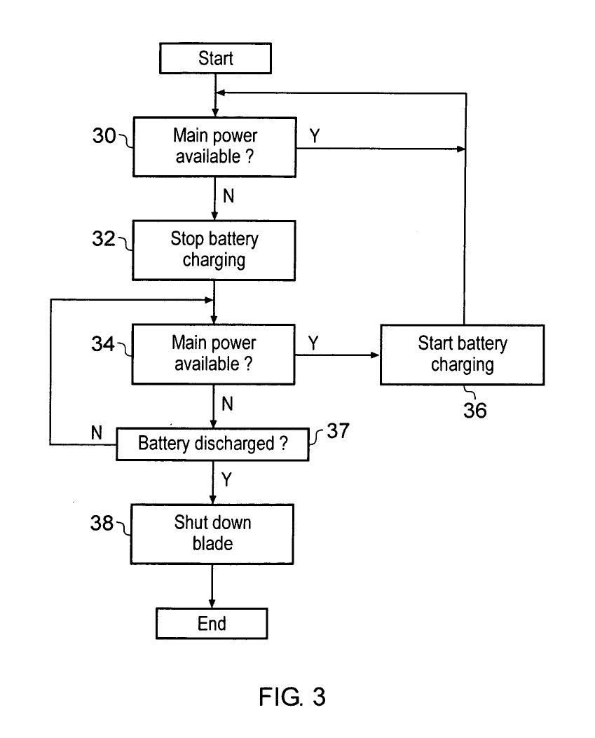

FIG. 3 is a flow diagram schematically illustrating the control of the charging of the on-board backup power supply. It will be appreciated that whilst FIG. 3 is shown as a sequential process, in practice many of the steps may be performed in parallel or in a different order.

At step 30 the system continuously checks whether the main power supply is available. If the main power supply is unavailable (e.g. as detected by the power controller circuitry 18), then processing proceeds to step 32 where charging of the power supply batteries 14, 16 provided on each of the blade servers 2 is stopped. The processor 6 on each of the blade servers 2 is able to continue its normal processing operation as power is supplied form the power supply batteries 14, 16 that are now discharging. At step 34 a check is made as to whether or not the main power supply has been restored. If the main power supply has been restored, then step 36 restarts battery charging and processing is returned to step 30. If the determination at step 34 is that the main power supply is still unavailable, then step 37 checks whether the power supply batteries 14, 16 are yet fully discharged. If they are not yet fully discharged, then they may continue to supply power to the individual blade server concerned and processing returns to step 34. If the determination at step 37 is that the power supply batteries 14, 16 are discharged, then step 38 serves to shut down the blade server 2 concerned, such as via an appropriate call to the operating system software executing on that blade server 2. Thus, the blade server 2 may perform a graceful shutdown. It is also possible that the on-board batteries of another blade server could be used to supply power to a blade server with exhausted batteries or in order to deal with a peak in power requirements. The power controllers can communicate and co-ordinate via the electrical connections to share power in this way.

In order to maintain the on-board power supply batteries 14, 16 in good condition it is desirable to periodically exercise these batteries. Exercising a battery involves partially discharging the battery and then recharging the battery to its full capacity. When two or more on-board power supply batteries 14, 16 are provided, then these may be periodically exercised during non-overlapping periods in order that they are both maintained in good condition whilst the overall backup capacity is not unduly compromised.

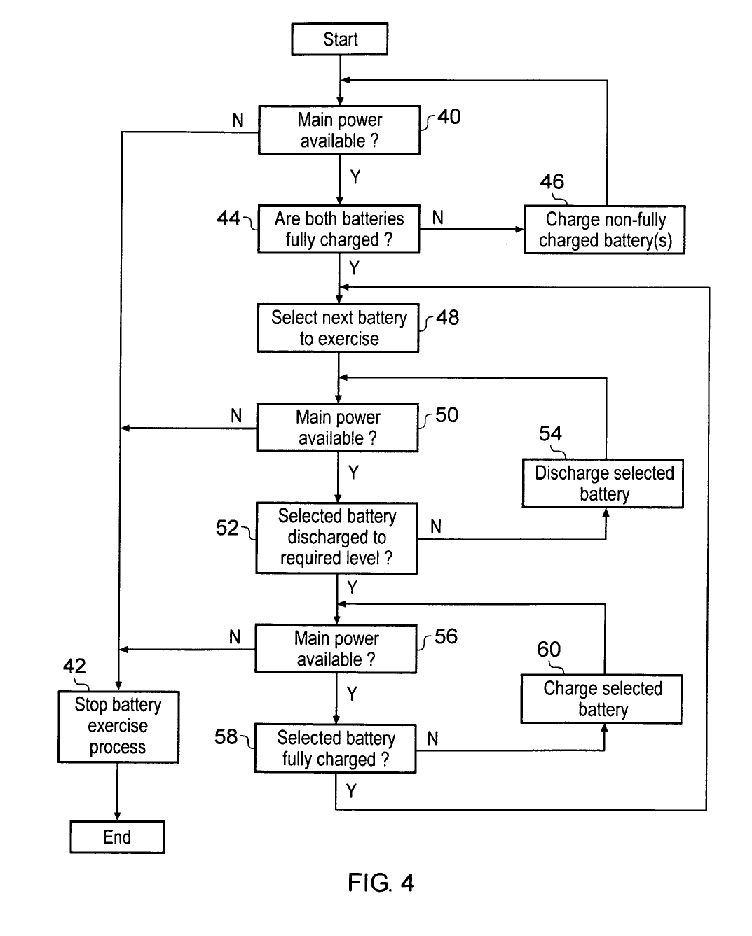

FIG. 4 illustrates one way in which the exercising of the power supply batteries 14, 16 may be performed. It will be appreciated that the flow diagram of FIG. 4 is sequential and that in practice the processing steps performed may be achieved in a different order, or with certain steps performed in parallel. At step 40 a determination is made as to whether main power is available. If main power is not available, then processing proceeds to step 42 where battery exercising is stopped and the on-board power supply batteries 14, 16 are used as the power source for the blade server 2. This stopping of the battery exercising corresponds to step 32 in FIG. 3. It will be appreciated that the control performed by both FIG. 3 and FIG. 4 may be performed in parallel.

If the determination at step 40 is that the main power supply is available, then step 44 determines whether or not both of the power supply batteries 14, 16 are fully charged. If they are not both yet fully charged, then step 46 serves to charge the non-fully charged battery or batteries 14, 16 and processing is returned to step 40 until the determination at step 44 is that both batteries are fully charged.

When both batteries 14, 16 are fully charged, then processing proceeds to step 48 where the next battery to be exercised is selected. The example illustrated has two power supply batteries, 14, 16 provided on-board the blade server 2. It may be that more than two such power supply batteries 14, 16 are provided. In each case, the battery selected for exercise will start from a given battery and will proceed in turn to the remaining batteries on a round-robin basis. In the case of two power supply batteries 14, 16, the battery to be exercised will be selected to alternate between the two batteries 14, 16.

At step 50 a determination is again made as to whether the main power supply is available. If the main power supply is not available, then processing proceeds to step 42 as before. If the main power supply is available, then step 52 determines whether the selected battery has yet been discharged to the required level. If the selected battery has not yet been discharged to the required level, then processing proceeds to step 54 where the selected battery is subject to a discharge. This discharge may be achieved by switching the selected battery such that it drives a current through a resistive load to discharge the selected battery in a controlled fashion at a controlled rate. Alternatively, the selected battery could be used to power the blade server 2 instead of the main power supply in order to discharge the selected battery even though the main power supply is available. After step 54, processing again returns to step 50. If the determination at step 52 is that the selected battery has been discharged to the required level (e.g. 80% of its maximum charge), then processing proceeds to step 56. At step 56 a determination is again made as to whether or not the main power supply is available. If the main power supply is not available, then processing proceeds to step 42. If the main power supply is available, then step 58 determines whether or not the selected battery has yet been fully recharged. If the selected battery has not yet been fully recharged, then processing proceeds to step 60 where the selected battery is charged and processing returned to step 56. The control passes around the loop of step 56, 58 and 60 until the selected battery has been fully recharged. When the selected battery has been fully recharged as determined at step 58, processing is returned to step 48 where the next battery to be exercised is selected. Such periodic discharge and recharge may be desirable for battery conditioning when using, for example, NiCd or NiMH batteries. Other battery technologies, such as Lead-Acid or Li-Ion may not require such conditioning cycles, but may nevertheless benefit from this process as it enables the capacity of the battery to be checked against its nominal capacity as an indicator of battery health. The battery capacity may be determined as a percentage of its nominal capacity and compared with a threshold health value (e.g. a threshold value set by a user).

Thus, at an overall level, the flow diagram of FIG. 4 illustrates how a determination is first made that both of the batteries are fully charged before the exercise process begins. Once both batteries are fully charged, then they are selected in turn for exercise. During a discharge phase processing proceeds around the loop of steps 50, 52 and 54 until the selected battery has been discharged to the required level. Once the selected battery has been discharged to the required level, then processing proceeds around the loop of steps 56, 58 and 60 until it has been recharged to a fully charged state. At this point, processing returns to step 48 where the next battery is selected for exercise. Throughout the processing illustrated in FIG. 4, a check is made upon the availability of the main power supply and if the main power supply is not available, then the exercise process is abandoned.

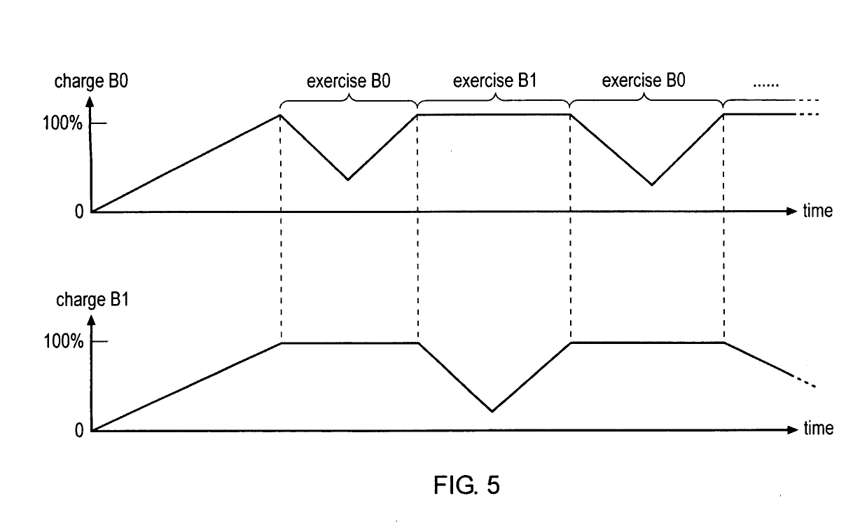

FIG. 5 schematically illustrates how the charge on the power supply batteries 14, 16 will vary with time when operating in accordance with the control flow of FIG. 4. Initially both batteries are charged up to a fully charged state. The exercise of the batteries starts with battery B0. This is first discharged (e.g. to 30% capacity—consuming most or all of the stored charge) and then recharged. The battery B1 is then selected for exercise and this is in turn discharged and recharged. The exercise of the batteries then switches between the two power supply batteries 14, 16 in return. It may be that the batteries only need be subject to such a discharge and recharge operation once every few days or weeks and thus a long delay may be incorporated between the cycles of discharge and recharge during which delay both power supply batteries 14, 16 maintain a fully charged state.

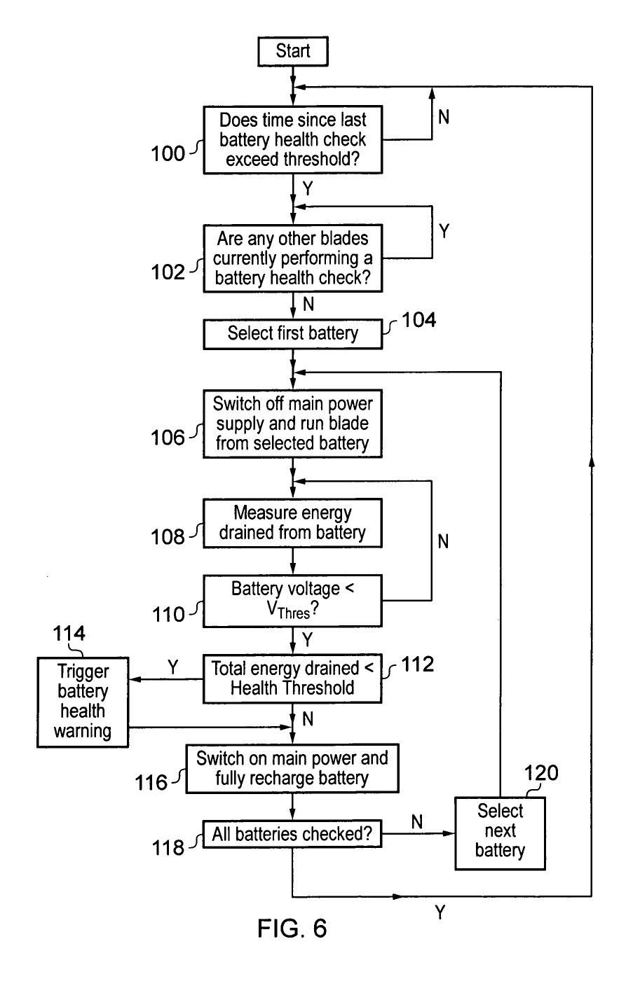

FIG. 6 is a flow diagram schematically illustrating the control of discharging and recharging of the batteries on a blade 4 as managed by the power controller circuitry 18. At step 100 the process waits until the time since the last battery health check sequence for that blade exceeds a threshold value. Thus, each blade may be set up to perform a health check upon its backup batteries once every month or at some other period appropriate to the nature of the batteries concerned and their rate of degradation.

When step 100 determines that it is time for the next battery health check to be performed, processing proceeds to step 102. At step 102 the power controller circuitry determines whether there are any other blades within an associated group of blades that are currently performed their own battery health check. The group of blades may comprise all of the blades within a blade enclosure 22, or some other grouping, such as all of the blades within a server farm facility. The purpose of the check at step 102 is that only one blade should be performing its health check at any give time. Thus, the remaining blades will have their batteries at their fully charged state should a main power failure occur during the health check. Accordingly, even though an individual battery on a blade may have been discharged as part of the health check operations, the remaining batteries on that blade and the batteries on other associated blades may together supply power to the blade which is undergoing the health check and accordingly compensate for the unfortunate coincidence of the main power failure with the battery health check operation. If all of the blades were permitted to perform their health checks at the same time, then a situation could arise where a significant proportion of the batteries were discharged due to a partially performed health check operation when a main power failure actually occurred.

After step 102 has performed any necessary wait until there are no other blades currently performing a battery health check, processing proceeds to step 104 where a first battery within the plurality of batteries 14, 16 provided on a blade 4 is selected. Step 106 then switches off the main power supply such that the blade 4 is powered from the selected battery in a manner that discharges the selected battery. Step 108 measures the energy drained from the battery in a given period of time. Step 110 checks to see if the output voltage of the selected battery has fallen below a threshold level indicative of that selected battery being substantially fully discharged. If the battery voltage has not fallen below the threshold level, then the process returns to step 108 where the next increment of energy is drained from the battery concerned. Thus, by cycling around steps 108 and 110 the selected battery is drained down to the point at which its output voltage falls below the threshold level and a measure is made of the total amount of energy which the selected battery provided during this discharge.

Following step 110 when the selected battery has an output voltage below the threshold level step 112 determines whether the total amount of energy that has been supplied by that battery is less than a health threshold level. This health threshold level may be set as a proportion of the nominal capacity of the selected battery. Thus, if the selected battery is rated at 5 Amp Hours at its nominal output voltage and the energy supplied by that battery as measure in steps 108 and 110 is below a user settable proportion of this nominal capacity, then this will fail the health threshold test and processing proceeds to step 114 where issuance of a battery health warning is triggered. This battery health warning may, for example, be activation of a warning light on the relevant blade server 4, the generation of a message, such as an email message, sent to a system administrator, or a variety of other warning techniques.

Subsequent to the check of the measured capacity of the selected battery against the nominal capacity and the generation of any necessary health warning, processing proceeds to step 116 where the main power is again switched on and the selected battery is fully recharged back to full capacity. This recharging is performed prior to the next battery being discharged and recharged so as to not compromise the survival time of the blade server on its backup battery power more than is necessary.

Once the selected battery has been fully recharged at step 116, processing proceeds to step 118 where a determination is made as to whether there are any more batteries upon the blade server 4 which require checking. If there are more batteries to be checked, then step 120 selects the next battery and processing returns to step 106. If all the batteries have been checked, then processing returns to step 100 waiting for the time to expire until the next battery health check for the blade is required.

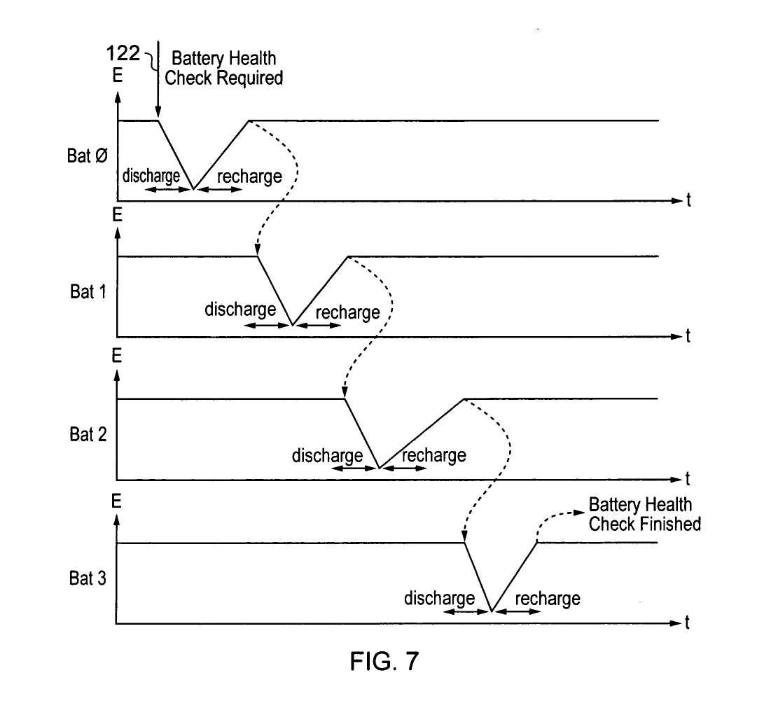

FIG. 7 is a diagram schematically illustrating the variation in the battery charge state of four separate on-blade batteries during a battery health check cycle. At time 122 the battery health check cycle is initiated. The first battery to be discharged and then recharged is battery 0. The battery is discharged down to nearly zero remaining capacity (as indicated by a relatively rapid fall off in the output voltage of the battery) followed by a recharge back to the fully charged state. It will be noted that the rate of discharge and the rate of recharge need not necessary be the same. Whilst the battery is being discharged, the product of the output voltage supplied and the current supplied may be calculated and integrated with time so as to give a measure of the energy supplied by that battery. This total amount of energy can be compared with a nominal total amount of energy that the fully charged battery should supply. If the proportion of the nominal capacity of the battery has measured falls below a predetermined threshold (such as a user set threshold), then a health warning for that battery may be issued indicating that the system user should swap that battery out of use.

After battery 0 has fully recharged, then the discharge and recharge of battery 1 is triggered. In a similar way, once battery 1 has fully recharged, then the discharge and recharge of battery 2 is triggered followed by the discharge and recharge of battery 3. Thus, each of the plurality of batteries provided on the blade are periodically (e.g. once a month, once a day, etc) and in turn subject to a discharge and then a recharge operation. The discharge and the recharge operation may be useful in preserving the battery condition in the case of certain battery chemistries, such as NiCd batteries and NiMH batteries. Other battery technologies, such as Lead-Acid batteries and Li-Ion batteries do not require such conditioning but may nevertheless benefit from the present techniques since an early indication of their failure may be obtained by detecting when they are no longer capable of providing greater than a threshold capacity upon discharge.

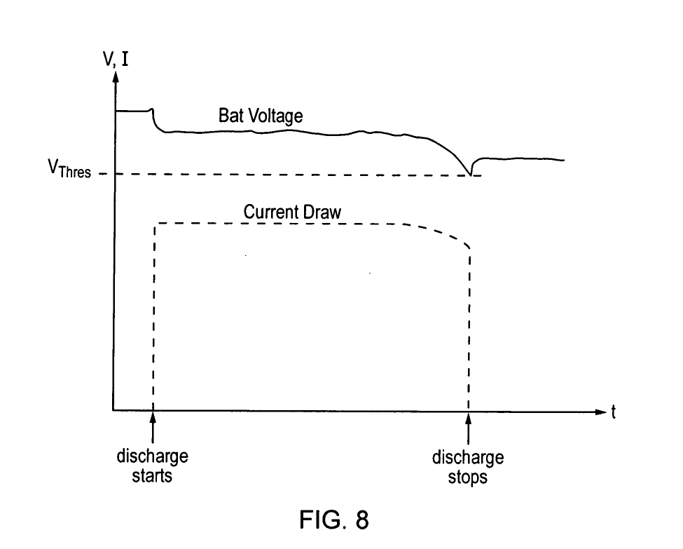

FIG. 8 schematically illustrates how the output voltage and current drawn from a battery varies with time as it is discharged. When the discharge starts, the current being drawn increases and the output voltage falls slightly. The output voltage will remain roughly constant and supply a roughly constant current until the battery nears exhaustion. At the time when the battery is reaching the end of its capacity, the output voltage will relatively rapidly diminish to reach a threshold value indicative of the battery being fully discharged. Discharging beyond this point may be harmful to the battery. Accordingly, discharge is stopped at this time. The output voltage may slightly rise by virtue of a “bounce” phenomenon when no current is being drawn from the battery although this does not indicate that the battery has recharged itself. This type of behaviour is known in the field.

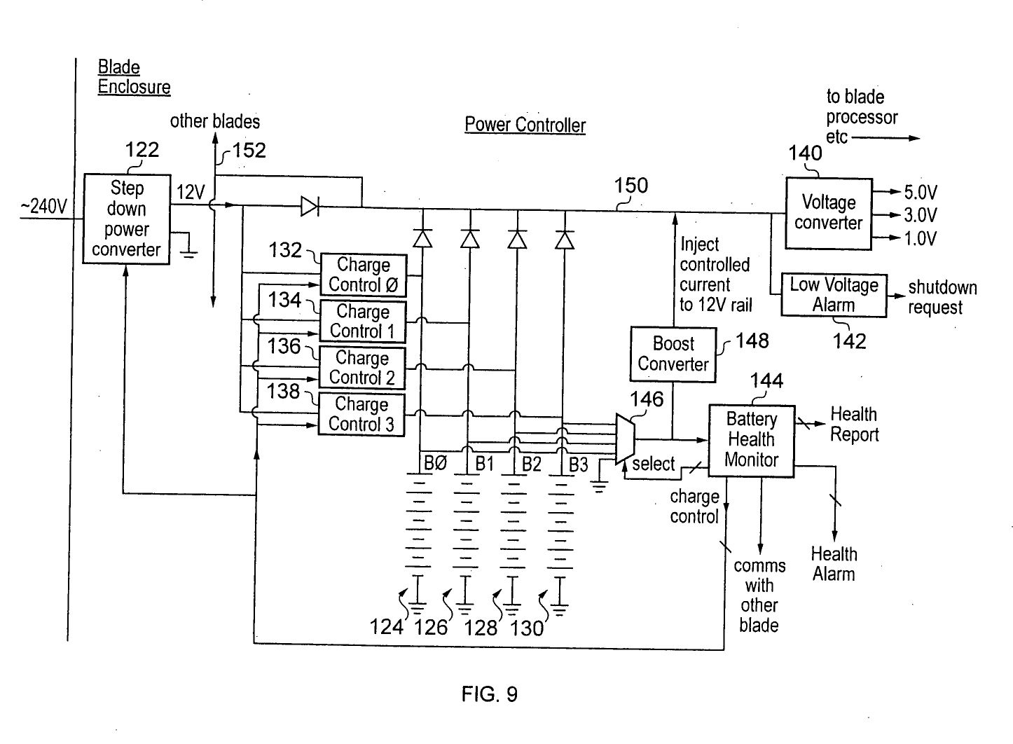

FIG. 9 schematically illustrates a portion of the power controller circuitry which may be provided on a blade. A step down power converter 122 provided within the blade enclosure may be responsible for converting a main supply voltage (e.g. 240 Volts or 110 Volts) down to a nominal lower voltage, such as 12 Volts for supply across an electrical connector to an individual blade server 4. The blade server 4 includes a plurality of power supply batteries 124, 126, 128, 130 which are each associated with a charge controller 132, 134, 136, 138. The charge controllers 132, 134, 136, 138 serve to maintain the power supply batteries 124, 126, 128, 130 fully charged when the main power supply is active. Should the main power supply fail, then the plurality of power supply batteries 124, 126, 128, 130 together serve to supply electrical power to the rest of the blade server via a voltage converter 140 which converts the nominal 12 volts or less as supplied by the batteries 124, 126, 128, 130 into the different voltage levels required by the electrical circuitry of the remainder of the blade server. A low voltage alarm 142 serves to monitor when the voltage converter 140 is not supplied with sufficient power to enable it to reliably generate the voltages it must output and accordingly serves to trigger a shut down request to the blade server 4 as necessary.

A battery health monitor 144 (which may be provided in the form of a microcontroller) serves to control the health monitoring processes performed on the batteries 124, 126, 128, 130 in accordance with the methodology illustrated in FIGS. 6, 7 and 8. In particular, the battery health monitor 144 determines when a predetermined period since the last battery health check has expired (e.g. a month) and then initiates a cycle of battery health checking. The battery health monitor 144 communicates with the power controller circuitry 18 of other blade servers in order to check that none of these other blade servers is currently performing a battery health check. When the battery health check is able to proceed, the battery health monitor 144 selects using the multiplexer 146 one of the batteries 124, 126, 128, 130 for heath checking. A predetermined amount of power is drawn from the selected battery and supplied via a boost converter circuit 148 to the 12 Volt rail 150, replacing part of the power normally supplied by the step down converter 122. If the voltage converter 140 does not require all of this power, then the remainder may pass to other blades via the shared power lines 152. These shared power lines also enable the power supply batteries on a given blade server to also help to support the power requirements of other blade servers in the case of a real power failure.

The battery health monitor 144 monitors the amount of current and the voltage supplied by the currently selected battery 124, 126, 128, 130 while it is under test and being discharged. When it is roughly fully discharged, then it is recharged under control of the battery health monitor 144 using the respective one of the charge controllers 132, 134, 136, 138 and the restoring the main power supply via the step down power converter 122. The capacity which has been measured for the battery tested is compared with a nominal capacity for that battery and if the battery does not reach a minimum threshold level of its nominal capacity, then a health alarm for that battery is issued as previously discussed. In addition, a routine health report may be generated for that battery even if it does meet its nominal capacity minimum requirements such that a system administrator may examine trends in battery performance and take early preventative maintenance steps if required. Following the discharge and recharge of one of the batteries 124, 126, 128, 130, a next battery is selected for the same discharge and recharging operation until all of the batteries have been so tested.

In another example embodiment the boost converter circuit 148 may be omitted and a selected battery to be heath check connected via multiplexer 146 to the 12 Volt rail 150. At the same time, the remaining batteries are isolated from the 12 Volt rail 150 (e.g. by switches (not illustrated) controlled by the health monitor 144) and the step down converter 122 is stopped from supplying power to the 12 Volt rail 150. Thus, the full power for the blade will be supplied by the selected battery which is monitored until it is discharged. When the selected battery is discharged, the step down converter 122 will be triggered to again supply power to the 12 Volt rail 150, the other batteries reconnected to the 12 Volt rail 150 and the selected battery recharged. The other batteries are then selected for discharge and recharge in turn. If the main power fails during such a health check cycle, then the health monitor 144 connects all batteries to the 12 Volt rail 150.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A blade server for connection to a blade enclosure as one of a plurality of blade servers connected to said blade enclosure, said blade server comprising:
at least one processor responsive to at least one stream of program instructions to perform processing operations;
an electrical connector configured to provide electrical connection with said blade enclosure, at least a main power supply for said at least one processor being passed from said blade enclosure through said electrical connector to said at least one processor;
a plurality of power supply batteries; and
power controller circuitry coupled to said plurality of power supply batteries and to said main power supply and configured:
(i) to provide a power supply to said at least one processor from at least one of said plurality of power supply batteries during an interruption of said main power supply such that said processor continues to be responsive to said stream of program instructions to perform said processing operations; and
(ii) periodically at least partially to discharge and to recharge each of said plurality of power supply batteries in turn.

2. A blade server as claimed in claim 1, wherein said plurality of power supply batteries are configured to at least selectively provide a power supply to another blade server via said electrical connector.

3. A blade server as claimed in claim 1, wherein said power controller circuitry includes communication circuitry configured to communicate with power controller circuitry of one or more other blade servers to co-ordinated management of said plurality of batteries with said power controller circuitry of said one or more other blade servers.

4. A blade server as claimed in claim 1, wherein said power controller circuitry monitors said at least partial discharge to determine a status parameter of each of said plurality of batteries, said status parameter being indicative of a measured capacity of a given battery.

5. A blade server as claimed in claim 4, wherein said status parameter is indicative of said measured capacity as a proportion of a nominal capacity of said given battery.

6. A blade server as claimed in claim 4, wherein said power controller circuitry is responsive to said measured capacity falling below a threshold value to generate a message indicating that said given battery should be replaced.

7. A blade server as claimed in claim 1, wherein said main power supply is derived from a main power supply source have a main power supply voltage and said power controller circuitry is configured to provide power to said at least one processor without forming a power supply at said main power supply voltage.

8. A blade server as claimed in claim 1, wherein said power controller circuitry is configured to charge said at least one power supply battery using said main power supply.

9. A blade server as claimed in claim 1, wherein said electrical connector also passes one or more further signals between said blade enclosure and said blade server, said one or more further signals including at least one of:
a network transmission signal;
a data signal exchanged with a non-volatile storage media; and
a status signal indicative of a current status of said blade server.

10. A blade server array comprising:
a blade enclosure; and
a plurality of blade servers connected to said blade enclosure, wherein
at least one of said plurality of said blade servers comprises:
at least one processor responsive to at least one stream of program instructions to perform processing operations;
an electrical connector configured to provide electrical connection with said blade enclosure, at least a main power supply for said at least one processor being passed from said blade enclosure through said electrical connector to said at least one processor;
a plurality of power supply batteries; and
power controller circuitry coupled to said plurality of power supply batteries and to said main power supply and configured:
(i) to provide a power supply to said at least one processor from at least one of said plurality of power supply batteries during an interruption of said main power supply such that said processor continues to be responsive to said stream of program instructions to perform said processing operations; and
(ii) periodically at least partially to discharge and to recharge each of said plurality of power supply batteries in turn.

11. A blade server array as claimed in claim 10, wherein said plurality of power supply batteries are configured to at least selectively provide a power supply to another blade server within said blade server array via said electrical connector.

12. A blade server array as claimed in claim 10, wherein said power controller circuitry includes communication circuitry configured to communicate with power controller circuitry of one or more other blade servers to co-ordinated management of said plurality of batteries with said power controller circuitry of said one or more other blade servers.

13. A blade server array as claimed in claim 10, wherein said power controller circuitry monitors said at least partial discharge to determine a status parameter of each of said plurality of batteries, said status parameter being indicative of a measured capacity of a given battery.

14. A blade server array as claimed in claim 13, wherein said status parameter is indicative of said measured capacity as a proportion of a nominal capacity of said given battery.

15. A blade server array as claimed in claim 13, wherein said power controller circuitry is responsive to said measured capacity falling below a threshold value to generate a message indicating that said given battery should be replaced.

16. A blade server array as claimed in claim 10, wherein said main power supply is derived from a main power supply source have a main power supply voltage and said power controller circuitry is configured to provide power to said at least one processor without forming a power supply at said main power supply voltage.

17. A blade server array as claimed in claim 10, wherein said power controller circuitry is configured to charge said at least one power supply battery using said main power supply.

18. A blade server array as claimed in claim 10, wherein said electrical connector also passes one or more further signals between said blade enclosure and said blade server, said one or more further signals including at least one of:
a network transmission signal;
a data signal exchanged with a non-volatile storage media; and
a status signal indicative of a current status of said blade server.

19. A blade server array as claimed in claim 10, wherein each of said plurality of blade servers comprises:
at least one processor responsive to at least one stream of program instructions to perform processing operations;
an electrical connector configured to provide electrical connection with said blade enclosure, at least a main power supply for said at least one processor being passed from said blade enclosure through said electrical connector to said at least one processor;
a plurality of power supply batteries; and
power controller circuitry coupled to said plurality of power supply batteries and to said main power supply and configured:
(i) to provide a power supply to said at least one processor from at least one of said plurality of power supply batteries during an interruption of said main power supply such that said processor continues to be responsive to said stream of program instructions to perform said processing operations; and
(ii) periodically at least partially to discharge and to recharge each of said plurality of power supply batteries in turn.

20. A blade server means for connecting to a blade enclosure means for housing a plurality of blade server means connected to said blade enclosure means, said blade server means comprising:
at least one processor means for performing processing operations in response to at least one stream of program instructions;
electrical connector means for providing electrical connection with said blade enclosure means, at least a main power supply for said at least one processor means being passed from said blade enclosure means through said electrical connector means to said at least one processor means;
a plurality of power supply battery means for storing electrical energy; and
power controller means coupled to said plurality of power supply battery means and to said main power supply:
(i) for providing a power supply to said at least one processor means from at least one of said plurality of power supply battery means during an interruption of said main power supply such that said processor means continues to be responsive to said stream of program instructions to perform said processing operations; and
(ii) periodically at least partially for discharging and for recharging each of said plurality of power supply battery means in turn.

21. A blade server array means comprising:
blade enclosure means; and
a plurality of blade server means connected to said blade enclosure means,
wherein
at least one processor means for performing processing operations in response to at least one stream of program instructions;
electrical connector means for providing electrical connection with said blade enclosure means, at least a main power supply for said at least one processor means being passed from said blade enclosure means through said electrical connector means to said at least one processor means;
a plurality of power supply battery means for storing electrical energy; and
power controller means coupled to said plurality of power supply battery means and to said main power supply:
(i) for providing a power supply to said at least one processor means from at least one of said plurality of power supply battery means during an interruption of said main power supply such that said processor means continues to be responsive to said stream of program instructions to perform said processing operations; and
(ii) periodically at least partially for discharging and for recharging each of said plurality of power supply battery means in turn.

22. A method of providing electrical power to a blade server within a blade enclosure, said method comprising the steps of:
when a main power supply is available, supplying said main power supply to said blade server via a blade enclosure and an electrical connector providing an electrical connection between said blade enclosure and said blade server;
when said main power supply is not available, using a battery power supply from a plurality of power supply batteries formed as part of said blade server to power said blade server such that said blade server continues to execute program instructions; and
periodically at least partially discharging and recharging each of said plurality of power supply batteries in turn.
